(19) United States
(12) Patent Application Publication
(10) Pub. No.: US 2009/0068632 A1
(43) Pub. Date: Mar. 12, 2009

(54) Mountable writing assembly

(75) Inventors: Craig Thompson, Inver Grove Heights, MN (US); Russell G. Pihlstrom, Austin, MN (US); Dana M. Vajen, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/899,716

(22) Filed: Sep. 7, 2007

(51) Int. Cl. B43L 1/00

(52) U.S. Cl. 434/416

(57) ABSTRACT

A mountable writing assembly includes a cover member, a visually transparent writing member, a replaceable sheet for displaying personalized information or images, and a backing member removably retained in the cover member. A method of allowing a user to create a customized dry-erase board is also disclosed.

### BACKGROUND

The present invention relates generally to erasable writing surfaces, and more particularly, to a mountable writing assembly including a transparent erasable writing surface.

Erasable writing surfaces, including whiteboards and dry-erase boards, are commonly used in offices, conference rooms, and school classrooms. Whiteboards include a hard non-porous surface that may be constructed of melamine resin or porcelain enameled steel. Special whiteboard erase makers containing ink that can generally be removed from the whiteboard are designed to be used with whiteboards.

Whiteboards are also known in the prior art. PCT Publication WO 2004/011269 (Athorn-Telep), for example, discloses an article for use as a dry erase media. U.S. Pat. No. 7,255,566 (Galbraith Coates) discloses a write-on wipe-off book holder.

The industry is always seeking improved erasable writing surfaces, and improved methods of allowing users to use such surfaces.

### SUMMARY

The need exists for an erasable writing surface that can be adhesively mounted to the surface of, for example, a wall, door, or piece of furniture, and which is versatile, inexpensive, and easy to make, use and maintain.

The present invention provides a mountable writing assembly including a cover member containing a recessed cavity region and a central viewing area, a visually transparent writing member arranged in the recessed cavity region of the cover member adjacent the central viewing area, wherein the writing surface has a first major surface suitable for erasable writing and a second major surface opposite the first major surface, a backing member arranged adjacent the writing member second major surface, and a retaining mechanism arranged to removably retain the writing member and the backing member in the recessed cavity region of the cover member.

In one embodiment, the writing member may be rigid and formed of a material such as glass, and in another embodiment, the writing member may be flexible and formed of a thin sheet of material such as polyethylene terephthalate (PET), polycarbonate, polypropylene, clear polystyrene, or acrylonitril butadiene styrene (ABS). In a more specific embodiment, the writing member may further comprise a hard coat layer, thereby to produce a more durable and non-porous writing surface.

In a more specific embodiment, the backing member is sufficiently rigid to retain the writing member in the recessed cavity region of the cover member when the writing assembly is in its fully assembled condition.

In another aspect of the invention, the writing assembly may include a graphic display member arranged between the writing member and the backing member. The graphic display member may include personalized information or images provided by the user. The graphic display member may be easily removed from the writing assembly, and replaced with a different graphic display member containing different information or images. In a specific embodiment, the graphic display member comprises a standard size sheet of printable media, such as an 8½×11 inch or A4 size sheet of paper, bearing personalized information or images.

In another aspect, the writing assembly further comprises a retaining mechanism for removably retaining a writing implement on the writing assembly. The writing assembly may also include a writing implement removably arranged on the retaining mechanism.

In another aspect, the writing assembly may include at least one stretch removable adhesive strip arranged on the back of the writing assembly for removably adhesively securing the writing assembly to a surface. The stretch removable adhesive strip may be arranged on the cover member, the backing member, or on separate clips that snap fit into the back of the cover member. In a more specific aspect, the stretch removable adhesive is a strip including an internal reclosable fastener that allows the adhesive strip to be repeatably separated and re-closed.

In another aspect, the invention provides a method of allowing an end user to create a customized dry-erase board by providing a cover member, arranging a visually transparent flexible writing member in the cover member, providing a sheet of material sized to fit in the cover member adjacent the flexible writing member, personalizing the sheet of material, thereby creating a personalized graphic display member, arranging the personalized graphic display member within the cover member adjacent the writing member, arranging a backing member within the cover member adjacent the personalized graphic display member, and removably securing the writing member, the sheet of material, and the backing member in the cover member. In more specific aspects, the sheet of material may be a sheet of paper or a printable sheet formed of a synthetic plastic material.

An advantage of certain embodiments of the invention include providing an erasable writing surface that is durable, easy to make and use, includes a transparent writing surface, includes a replaceable graphic sheet that can be customized by the end user, and is removably mountable to a surface.

### BRIEF DESCRIPTION OF THE DRAWINGS

The present invention will be further described with reference to the accompanying drawings, in which:

FIG. 1 is an exploded front view of a mountable writing assembly according to the invention;

FIG. 2 is an exploded rear perspective according to the invention;

FIG. 3 is a diagrammatic cross sectional view of the mounting assembly of FIG. 1; and

FIG. 4 is a perspective view of an alternate embodiment of the invention.

### DETAILED DESCRIPTION

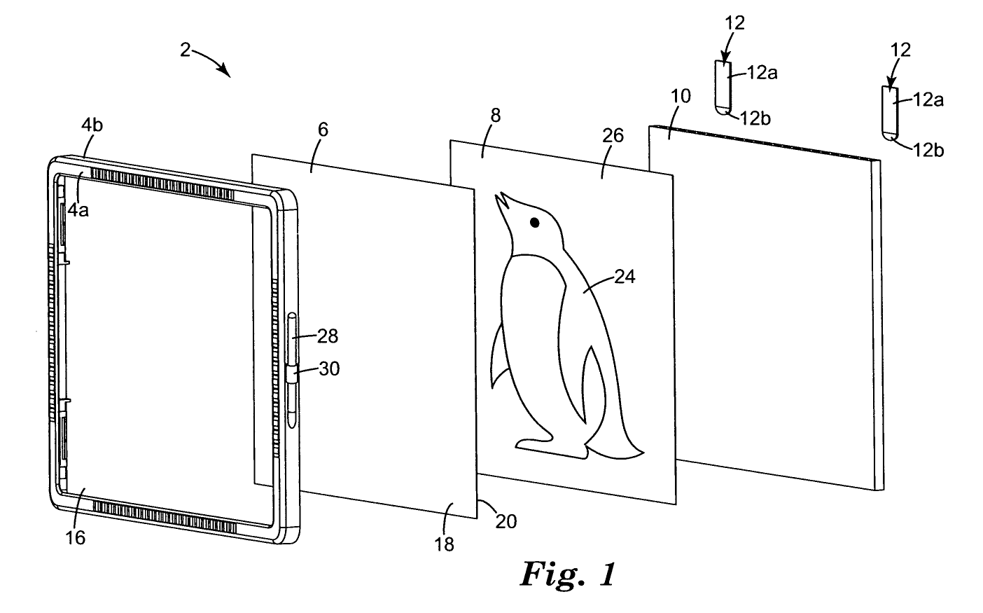

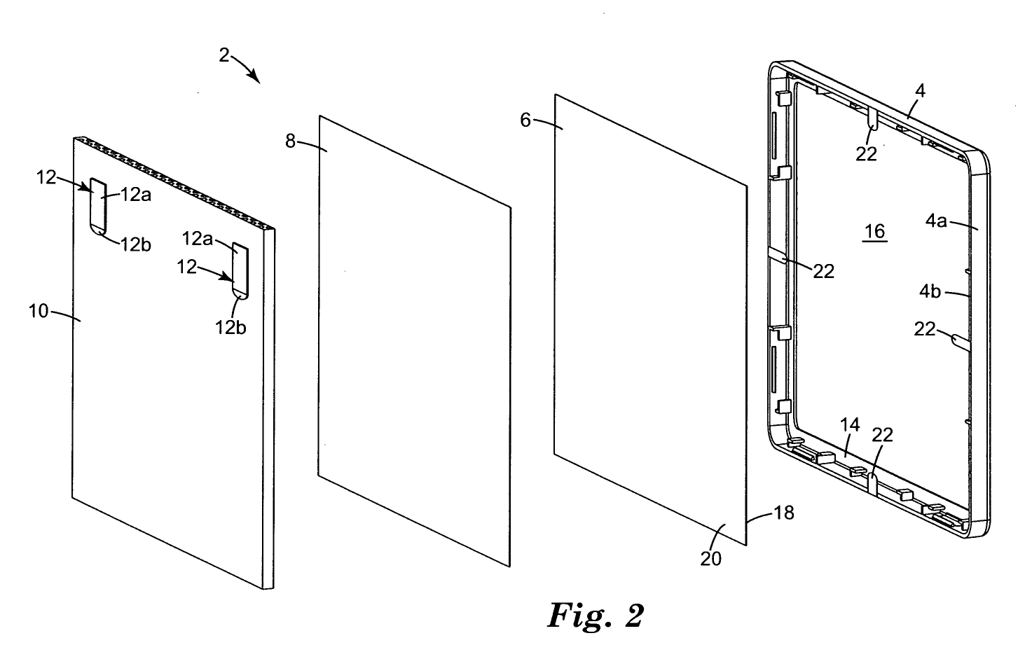

Referring now to the drawings, wherein like reference numerals refer to like or corresponding parts throughout the several views, FIGS. 1-3 shows a mountable writing assembly 2 including a cover member 4, a transparent writing member 6, a replaceable graphic display member 8, a backing member 10, and stretch removable adhesive strips 12 for removably bonding the assembly 2 to a surface, such as the surface of a wall or door.

The cover member 4 includes a front wall portion 4a, and a contiguous side wall portion 4b extending generally perpendicularly from the front wall portion 4a. The front wall portion 4a and side wall portion 4b combine to define a recessed cavity region 14 sized to receive the writing member 6, graphic display member 8, and backing member 10. That is, the side wall portion 4b extends a distance from the front wall portion 4a to define a recess depth that accommodates the combined thicknesses of the writing member 6, the graphic display member 8, and the backing member 10. The front wall portion 4a and side wall portion 4b also combine to define an opening 16 which serves as a central viewing area through which the graphic display member 8 may be viewed by a user. The cover member 4 is generally constructed to be stiff and inflexible, and may be formed of injected molded synthetic plastic materials, metals, wood, or other suitable materials.

The writing member 6 is arranged in the recessed cavity region 14 of the cover member 4 adjacent the opening 16. The writing member 6 may be attached or affixed to the cover member 4 using, for example, glue or adhesive, or the writing member 6 may be arranged loosely in the cover member 4 and held in place by the assembled writing assembly 2 itself. That is, the writing member 6 may be retained within the assembled writing assembly 2 by the structure or confines of the writing assembly 2 itself.

The writing member 6 includes opposed first and second major surfaces 18, 20, respectively, at least one of which is suitable for erasable writing using, for example, a non-permanent marker, such as those designed for whiteboards or dry-erase boards. Such non-permanent markers may be erased with a cloth, paper towel, or the like.

In accordance with one aspect of the writing assembly 2, the writing member 6 is clear or visually transparent. The writing member 6 may be formed of, for example, glass, or from synthetic plastic materials including polyester, such as polyethylene terephthalate (PET), polypropylene, polycarbonate, clear polystyrene, acrylonitril butadiene styrene (ABS), or polymethyl methacrylate materials. The writing member 6 may be rigid, or may be a thin flexible sheet of material having a minimum thickness of at least about 5 mils or at least about 10 mils, and a maximum thickness of no greater than about 30 mils or no greater than about 50 mils. In various embodiments, the writing member 6 may be a thin flexible sheet of PET or polypropylene. In a more specific embodiment, the writing member 6 may include hard coat layer arranged on at least the first major surface 18. Because it may be difficult for an end user to detect which surface of the writing member 6 includes the hard coat, both the first 18 and second 20 major surfaces of the writing member 6 may include a hard coat. The hard coat may be, for example, an acrylic hard coat, and, more specifically, a UV cured acrylic monomer hard coat.

In the illustrated embodiment, the writing assembly 2 includes an optional graphic display member 8 arranged between the writing member 6 and the backing member 10. The graphic display member 8 includes a first major surface 26 facing the cover member 4, and arranged adjacent the writing member 6. The graphic display member 8 first major surface 26 may include information, artwork, graphical images, indicia or the like 24. In one aspect, the graphical information is provided by the end user of the product. As such, the graphical information may be personalized or changed periodically to suit the personal preferences or needs of the user.

In one aspect, the graphic display member 8 comprises a standard size sheet of printable media, such as an 8½×11 inch or A4 size sheet of printable media bearing personalized indicia or graphics provided by the end user of the writing assembly 2. The sheet of printable media may be, for example, paper, or printable films formed of synthetic plastic materials. In this manner, an end user may create unique graphic displays for the graphic display member 8 using, for example, clip art or a wide variety of available computer software programs designed to create computer graphics or other artwork, or print photographs, and using available printers such as laser and/or ink jet type printers. It will be recognized that the paper may be of any size or weight, may be glossy, and may be paper commonly referred to as photo paper.

The backing member 10 is arranged adjacent the graphic display member 8. In one aspect, the backing member 10 is sufficiently stiff or rigid to retain the writing member 6 and the graphic display member 8 in the cover member 4 when the writing assembly 2 is in its fully assembled condition. That is, when the writing assembly 2 is fully assembled, the backing member 10 holds both the writing member 6 and the graphic display member 8 in place, but when the writing assembly 2 is disassembled and the backing member 10 is removed, the writing member 6 and the graphic display member 8 may be manually removed from the recessed cavity region 14 of the cover member 4.

In another aspect, the backing member 10 includes a hard surface that allows a user to write on the writing member 6. That is, if the writing member 6 and/or the graphic display member 8 cannot be effectively written on, the backing member 10 provides a sufficiently stiff and hard surface to allow a user to write on the writing member. The backing member 10 may be formed of a variety of materials including synthetic plastic materials, paperboard, cardboard, wood, or laminates.

Retaining mechanisms 22, such as clips, clasps, or other available fasteners are arranged on the back of the cover member 4 to removably retain the backing member 10, and hence the writing member 6, in the cover member 4. The retaining mechanisms 22 are movable between an open position which allows the backing member 10 to be either placed in, or removed from, the cover member 4, and a retaining position in which the backing member 10 is held in place within the recessed cavity region 14 of the cover member 4. The particular form of the retaining mechanism 22 selected is not significant to the invention hereof, so long as it provides the desired function of allowing the backing member 10 to be removably retained within the recessed cavity region 14 of the cover member 4. For example, the retaining mechanism may include separate pieces that snap fit into the back of the cover member 4.

In another aspect, the writing assembly 2 includes a writing implement 28, such as a non-permanent marker, and a holder 30 for removably retaining the writing implement 28 on the writing assembly 2. The holder 30 may be, for example, a clamp, a storage shelf, a magnetic system, or a hook-and-loop-type fastener arranged to removably secure the writing implement 28 to the writing assembly 2.

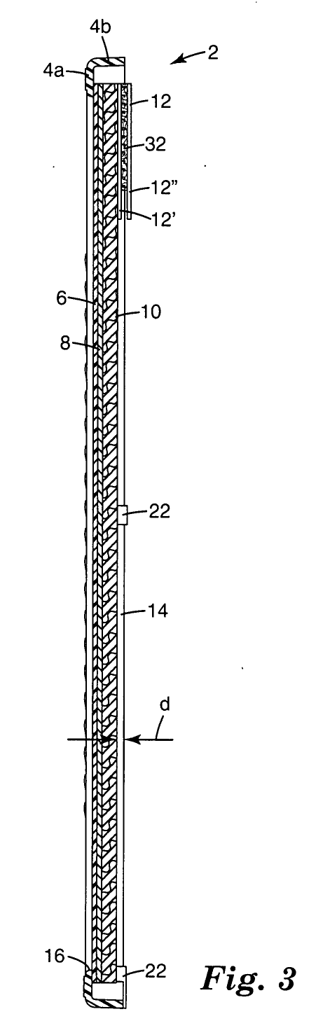

Stretch removable adhesive strips 12 are provided to removably adhere the writing assembly 2 to the surface of, for example, a wall, door, or piece of furniture. In the illustrated embodiment, a pair of adhesive strips 12 are provided for mounting the writing assembly 2 to a surface. It will be recognized that one or more such adhesive strips may be used depending, for example, on the size and/or weight of the writing assembly 2. In the illustrated embodiment, and as described more fully below with reference to FIG. 3, the adhesive strips 12 are arranged on the backing member 10. The adhesive strips 12 may also be arranged on the cover member 4 or on separate clips (not shown) that snap into the back of the cover member 4 to hold the writing member 6, graphic display sheet 8, and backing member 10 in place.

Referring now to in FIG. 3, the adhesive strip 12 has a thickness that is greater than the recess depth “d” between the back edge of the cover member 4 and the back surface of the backing member 10, whereby the exposed adhesive surface of the adhesive strip 12 extends beyond the back edge of the cover member 4. That is, when the writing member 6, graphic display member 8, and backing member 10 are arranged in the recessed cavity region 14 of the cover member 4, the surface of the backing member 10 opposite the graphic display member 8 may be recessed in the recessed cavity region 14 of the cover member 4, thereby defining a gap “d” between the backing member 10 and the back edge of the cover member 4. To allow an adhesive strip 12—which is adhered to the surface of the backing member 10—to also be adhesively bonded to a mounting surface (e.g. the surface of a wall, door, or piece of furniture) the thickness of the adhesive strip 12 will be at least equal to the depth of the gap By providing an adhesive strip 12 having a thickness greater than the gap distance “d”, the adhesive surface of the adhesive strip 12 will extend beyond the edge of the cover member 4, thereby allowing the adhesive strip 12 to make contact with the surface to which the writing assembly 2 is being adhered. Alternatively, the adhesive strip 12 may be arranged on the back of the cover member 4 instead of the back of the backing member 10, or on separate clips that snap fit into the back of the cover member 4 to retain the writing member 6, graphic display sheet 8, and backing member 10 in place within the recessed cavity region 14 cover member 4.

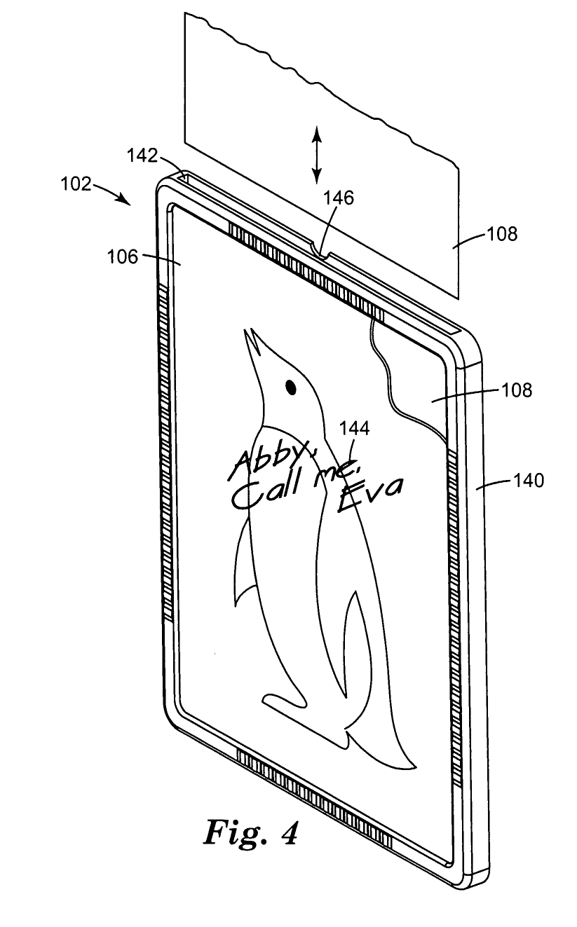

As shown in FIG. 4, the adhesive strip 12 may include a pair of stretch removable adhesive strips 12′, 12″ removably connected by a reclosable layer 32. The reclosable layer allows the adhesive strip 12′ and 12″ to be repeatably separated and re-closed. The reclosable layer 32 may be, for example, hook and loop fastener material, or other available mechanical interlocking materials, or a repeatably connectable adhesive.

Stretch removable adhesives are high performance pressure-sensitive adhesives that combine strong holding power with clean removal and no surface damage. The double-sided adhesive strips 12 may be any known stretch removable adhesive tape including a stretch removable adhesive tape with an elastic backing, a stretch removable adhesive tape with a highly extensible and substantially inelastic backing, or a stretch removable adhesive tape comprising a solid elastic pressure sensitive adhesive.

Stretch removable adhesive tapes suitable for use in the various embodiments of the present invention include the pressure sensitive adhesive tapes with highly extensible and substantially inelastic backings described in U.S. Pat. No. 5,516,581 (Kreckel et al.) and U.S. Pat. No. 6,231,962 (Bries et al.), U.S. Pat. No. 6,569,521 (Sheridan et al.), U.S. Pat. No. 7,078,093 (Sheridan et al.), and the solid elastic pressure sensitive adhesive described in German Patent No. 33 31 016. Other suitable stretch removable adhesive constructions include the stretch removable adhesive tape laminate including a separable fastener described in U.S. Pat. No. 6,972,141 (Bries et al.), the tape laminate comprising an internally separable layer described in U.S. Pat. No. 6,004,642 (Langford), and the elongate stretch removable tape constructions described in U.S. Pat. No. 6,641,910 (Bries et al.), and U.S. Pat. No. 6,541,089 (Hamerski et al.).

Suitable commercially available stretch removable adhesives include the double-sided stretch removable adhesive and 3M Picture Hanging Strips available from 3M Company, St. Paul, Minn. under the COMMAND trade designation. Commercially available COMMAND adhesive is currently manufactured as discrete strips with one end of the strip including a non-adhesive pull tab to facilitate stretching of the strip during removal.

The stretch removable adhesive strips 12 include an adhesive portion 12a, which may be positioned so that it is concealed by the writing assembly 2, and a non-adhesive pull tab portion 12b, which may be positioned to extend outwardly from behind the writing assembly 2. If the adhesive strips 12 include a separable fastener, such as is described in U.S. Pat. No. 6,972,141 (Bries et al.), the entire contents of which are hereby incorporated by reference, the adhesive strips 12 may be arranged such that both the adhesive portion 12a and the non-adhesive pull tab portion 12b of the adhesive strip may be concealed by the writing assembly 2. This is possible because each adhesive strip can be removed by first separating the adhesive strip via the separable fastener and then stretch removing each remaining half from its respective surface.

Referring now to FIG. 4, wherein functionally similar features to those in FIGS. 1-3 are referred to with like reference numerals incremented by 100, there is shown another mountable writing assembly 102 including a housing 140, a writing member 106, and a graphic display sheet 108. In this embodiment, the housing 140 may include a solid back surface (not shown) which allows the backing member 10 of FIGS. 1-3 to be omitted. Alternatively, the housing 140 may include an open back surface, and a backing member similar to backing member 10 may be included.

The housing 140 includes a recessed cavity that receives the writing member 106 and the graphic display sheet 108. The writing member 106 may be permanently affixed to the housing 140 or removably positioned within the housing. The top edge of the housing 140 contains a slot 142 which allows the graphic display sheet 108 to be readily inserted into and/or removed from the housing 140 manually. An access door (not shown) may be provided to conceal the slot 142. The housing 140 may be formed as a single-piece, unitary structure, or as two or more pieces that can be assembled, for example, by snapping the individual pieces together.

As shown in FIG. 4, the writing assembly 102 may be used by someone desiring to convey information to another person who is not present by writing a message 144 on the writing member 106. When the message 144 is received, it may be erased so additional messages may be written on the writing assembly 102.

In another aspect, the present invention provides a method of allowing an end user to create a customized dry-erase board. The method includes providing a cover member such as cover member 4, arranging a visually transparent flexible writing member such as writing member 6 in the cover member 4, providing a sheet of material such as the graphic sheet 8 sized to fit in the cover member 4 adjacent the flexible writing member, personalizing the sheet of material, thereby creating a personalized graphic display member, arranging the personalized graphic display member within the cover member adjacent the writing member, and arranging a backing member such as backing member 10 within the cover member adjacent the personalized graphic display member.

Persons of ordinary skill in the art may appreciate that various changes and modifications may be made to the invention described above without deviating from the inventive concept. Thus, the scope of the present invention should not be limited to the structures described in this application, but only by the structures described by the language of the claims and the equivalents of those structures.

What is claimed is:

1. A mountable writing assembly, comprising:
(a) a cover member defining a recessed cavity region and a central viewing area;
(b) a visually transparent writing member arranged in the recessed cavity region of the cover member adjacent the central viewing area, the writing surface having a first major surface suitable for erasable writing, and a second major surface opposite the first major surface;
(c) a backing member arranged adjacent the writing member second major surface; and
(d) a retaining mechanism arranged to removably retain the writing member and the backing member in the cover member.

2. A writing assembly as defined in claim 1, wherein the writing member is rigid.

3. A writing assembly as defined in claim 1, wherein the writing member is a flexible sheet.

4. A writing assembly as defined in claim 3, wherein the writing member is formed of a synthetic plastic material.

5. A writing assembly as defined in claim 4, wherein the synthetic plastic material is at least one of polyethylene terephthalate, polypropylene, clear polystyrene, or acrylonitril butadiene styrene (ABS).

6. A writing assembly as defined in claim 5, wherein the writing member further comprises a hard coat layer arranged on the first major surface.

7. A writing assembly as defined in claim 6, wherein the writing member further comprises a hard coat layer arranged on the second major surface.

8. A writing assembly as defined in claim 1, wherein the backing member is sufficiently rigid to retain the writing member in recessed cavity region of the cover member when the writing assembly is fully assembled.

9. A writing assembly as defined in claim 1, further comprising a graphic display member arranged between the writing member and the backing member.

10. A writing assembly as defined in claim 9, wherein the graphic display member is selected from at least one of an 8½×11 inch and an A4 size sheet of paper bearing personalized information or images thereon.

11. A writing assembly as defined in claim 1, further comprising a retaining mechanism for removably retaining a writing implement on the writing assembly.

12. A writing assembly as defined in claim 11, further comprising a writing implement arranged on the retaining mechanism.

13. A writing assembly as defined in claim 1, wherein the cover member includes a front portion and a side portion extending generally perpendicularly to the front portion, thereby defining the recessed region, and wherein the side portion defines a recess depth.

14. A writing assembly as defined in claim 1, wherein when the writing member, graphic display member, and the backing member are arranged in the cover member, the backing member is recessed in the recessed region to define a gap between the backing member and the edge of the side portion of the cover member.

15. A writing assembly as defined in claim 1, further comprising at least one stretch removable adhesive strip arranged on the back of the writing assembly for removably adhesively securing the writing assembly to a surface.

16. A writing assembly as defined in claim 15, wherein the stretch removable adhesive strip includes an internal reclosable fastener layer, thereby to allow the adhesive strip to be repeatably separated and re-closed.

17. A writing assembly as defined in claim 16 wherein the reclosable stretch removable adhesive strip has a thickness greater than the gap between the backing member and edge of the side portion of the cover member.

18. A mountable writing assembly, comprising:
(a) a unitary frame containing a recessed cavity region, a slot providing access to the recessed cavity region, and a central viewing area;
(b) a visually transparent writing member removably arranged in the recessed cavity region of the cover member adjacent the central viewing area, the writing surface having a first major surface suitable for erasable writing arranged within the central viewing area and a second major surface opposite the first major surface; and
(c) a graphic display member arranged adjacent the visually transparent writing member second major surface opposite the central viewing area.

19. A writing assembly as defined in claim 18, further comprising at least one stretch removable adhesive strip arranged on the back of the writing assembly for removably adhesively securing the writing assembly to a surface.

20. A method of allowing an end user to create a customized dry-erase board, comprising the steps of:
(a) providing a cover member;
(b) arranging a visually transparent flexible writing member in the cover member;
(c) providing a sheet of paper sized to fit in the cover member adjacent the flexible writing member;
(d) personalizing the sheet of paper, thereby creating a personalized graphic display member;
(e) arranging the personalized graphic display member within the cover member adjacent the writing member;
(f) arranging a backing member within the cover member adjacent the personalized graphic display member; and
(g) removably securing the writing member, the sheet of paper, and the backing member in the cover member.
